(19) United States
(12) Patent Application Publication
(10) Pub. No.: US 2014/0272749 A1
(43) Pub. Date: Sep. 18, 2014

(54) ORTHODONTIC APPLIANCES WITH TAPERED ARCHWIRE SLOTS

(71) Applicant: 3M INNOVATIVE PROPERTIES COMPANY, St. Paul, MN (US)

(72) Inventors: Lee C. Yick, Placentia, CA (US); Ming-Lai Lai, Arcadia, CA (US)

(21) Appl. No.: 14/350,019

(22) PCT Filed: Sep. 28, 2012
(86) PCT No.: PCT/US2012/057738

§ 371 Date: Apr. 4, 2014

Related U.S. Application Data
(60) Provisional application No. 61/545,361, filed on Oct. 10, 2011.

(51) Int. Cl. A61C 7/14

(52) U.S. Cl. CPC A61C 7/141
USPC 433/8; 264/16

(57) ABSTRACT

Provided are orthodontic appliances and related methods in which at least one region of at least one sidewall of an archwire slot is tapered relative to an opposing sidewall. This feature can allow the archwire slot to conform to the slight twist that occurs in the archwire when the archwire is placed in asymmetric torque. Advantageously, this feature can distribute the contact stress between the archwire and appliance over a much larger surface area compared with conventional appliances, leading to a dramatic and surprising increase in torque strength and providing other ancillary benefits.

### FIELD OF THE INVENTION

Provided are appliances and related methods used in orthodontic treatment. More particularly, fixed appliances and related methods are provided that receive and retain an archwire when used in orthodontic treatment.

### BACKGROUND

Orthodontics is a specialized field of dentistry concerned with the movement of teeth from maloccluded positions to proper positions in the oral cavity. Orthodontic treatment is usually carried out by a practitioner, who performs the diagnosis, treatment planning, placement of orthodontic appliances, and supervises treatment until a desired outcome is achieved. Numerous benefits can derive from orthodontic treatment, including improvements in facial aesthetics, bite function, and ease of maintaining dental hygiene.

One common type of orthodontic treatment, called fixed appliance therapy, involves coupling appliances to the surfaces of a patient's teeth. Such fixed appliances include, for example, brackets and molar tubes. Brackets are tiny slotted devices that may be bonded either to the front or the back surfaces of the teeth. Molar tubes have fully enclosed passageways and are generally affixed to the posterior teeth. To commence treatment, a resilient “U”-shaped archwire is placed into the slots of the brackets, with the ends of the archwire captured in the molar tubes. Although the archwire is contorted when initially engaged to the fixed appliances, it exerts gentle continuous forces that gradually move the teeth toward desired positions as it returns toward its original shape. In common parlance, the brackets, tubes, and archwire are collectively known as “braces.”

At the outset of treatment, archwires having small cross-sectional areas are generally used to facilitate engagement into the brackets when the teeth are crooked. As the teeth move toward their proper locations, however, these can be replaced with archwires having progressively larger cross-sections. Some orthodontic wires have rectangular cross-sectional shapes that complement the cross-sectional shape of the archwire slot, thereby enabling the archwire to impart torque (or twisting forces) to the associated tooth. Toward the end of treatment, practitioners may elect to use full-sized archwires having cross-sectional shapes that nearly match those of the archwire slots. By “filling the slot” in this manner, the practitioner has a high degree of control and can apply precise corrective forces to the teeth.

### SUMMARY

In the course of treatment, archwires transmit various types of loads (or forces) to the teeth, depending on the type of movement desired by the practitioner. For example, an archwire can apply forces that translate the tooth (first order), apply angulation forces along the plane of the facial tooth surface (second order), or apply torque about the longitudinal axis of the archwire (third order). The magnitude of these forces can also vary significantly depending on the nature of the malocclusion relative to the shape of the archwire when relaxed. To engineer an appliance that is not only efficient but also practical and comfortable to the patient can present a technical dilemma. On one hand, the appliance should be as small and flat as possible to reduce irritation and maximize bond reliability and improve aesthetics. On the other hand, appliances should not be too small, or they could become prone to breakage resulting from forces imparted by the archwire during treatment.

Appliance breakage can be of particular concern with respect to non-metal brackets, such as translucent ceramic materials. While these materials may offer numerous benefits, such as excellent hardness, stain resistance, and superior aesthetics compared with metals, they are also inherently brittle and can be susceptible to sudden and unexpected fractures. One failure mode of ceramic brackets arises in torque, where one or both tiewings fracture when twisting forces are applied by an archwire received in the bracket slot. While this problem may be solved by thickening the walls of the archwire slot, this is not an ideal solution since doing so generally increases the size of the bracket, thus increasing bracket profile and decreasing patient comfort.

It was also discovered that a bracket made from a brittle material is especially vulnerable to fracture when the torque is applied asymmetrically—that is, where one end of the wire is twisted to a greater extent than the other end relative to the bracket. When this occurs, the wire adopts a twisted configuration where the corners of the wire are no longer straight but slightly helical. As a result, a substantial degree of contact stress occurs over a localized area along the archwire slot, typically near one of its ends. This localization of stress was found to promote appliance breakage. Based on this insight, it was discovered that a substantial improvement to torque strength can be realized by tapering one or both opposing sidewalls of the archwire slot to conform to the slight twist that occurs in an archwire when subjected to asymmetric torque. This modification aids in distributing the contact stress over a much larger surface area, leading to a dramatic and surprising increase in torque strength.

This improvement in bracket torque strength can be achieved without making major re-designs to the bracket body or modifying the bracket material. As a further advantage, only a very small degree of taper can be highly effective in enhancing torque strength of the bracket, resulting in minimal compromise to the control exerted by the archwire over the bracket. Adapting the archwire slot geometry to conform to a twisted archwire can also provide certain ancillary benefits. For example, alleviating this failure mode can enable a ceramic bracket to be made smaller than was previously possible. Further, avoiding point contacts between the archwire and bracket can help reduce notching and galling of a relatively soft archwire against a relatively hard ceramic bracket, resulting in decreased resistance to sliding.

In one aspect, an orthodontic appliance is provided. The orthodontic appliance comprises: a base; a body extending outwardly from the base; and an elongated archwire slot extending across the body along a generally mesial-distal direction, the slot at least partially bounded by a bottom wall and a pair of substantially planar sidewalls, wherein at least one region of at least one sidewall is tapered to provide a transverse slot dimension that varies along the length of the archwire slot, the pair of sidewalls having an relative angular deviation ranging from about 0.5 to about 10 degrees.

In another aspect, an orthodontic appliance is provided comprising: a base; a body extending outwardly from the base and having a pair of mesial tiewings and a pair of distal tiewings; an elongated archwire slot extending across the body and between each pair of mesial and distal tiewings, the archwire slot at least partially bounded by a pair of opposing mesial sidewalls adjacent the mesial tiewings and a pair of opposing distal sidewalls adjacent the distal tiewings, one or both of each respective pair of mesial and distal sidewalls being substantially planar and non-parallel.

In still another aspect, an orthodontic appliance is provided comprising: a base; a body extending outwardly from the base; and an elongated archwire slot extending across the body along a generally mesial-distal direction, the slot at least partially bounded by a bottom wall and a pair of opposing sidewalls, wherein at least one sidewall is tapered to provide a transverse slot dimension that varies along the length of the archwire slot, whereby the transverse slot dimension monotonically increases or decreases over about 30 to about 75 percent of the overall length of the archwire slot.

In yet another aspect, a method of enhancing torque strength in a ceramic orthodontic appliance is provided, comprising: providing a ceramic body; and providing an elongated archwire slot into the body, the archwire slot having a pair of opposing sidewalls and one or both sidewalls being tapered to provide a transverse dimension that varies along the length of the archwire slot whereby the interfacial contact area between a full-sized rectangular archwire received in the archwire slot and the appliance is substantially distributed along the length of the archwire slot as the archwire is twisted about its longitudinal axis.

### BRIEF DESCRIPTION OF THE DRAWINGS

FIG. 1 is a perspective view showing the facial, mesial, and occlusal sides of a slotted orthodontic appliance according to one embodiment, with features of the slot exaggerated for illustration purposes;

FIG. 2 is a view showing the facial side of the appliance of FIG. 1;

FIG. 3 is a view showing the mesial side of the appliance of FIGS. 1-2;

FIG. 4 is view showing the facial side of a slotted orthodontic appliance according to another embodiment, with features of the slot exaggerated for illustration purposes;

FIG. 5 is view showing the facial side of a slotted orthodontic appliance according to still another embodiment, with features of the slot exaggerated for illustration purposes;

FIG. 6 is a view showing the facial side of a slotted orthodontic appliance according to yet another embodiment, with features of the slot exaggerated for illustration purposes;

FIG. 7 is an elevational view of a test configuration used to determine the torque strength of an orthodontic appliance;

FIG. 8 is an enlarged fragmentary view of the test configuration of FIG. 7 with a test in progress;

FIG. 9 is a simulated stress profile of a conventional orthodontic appliance when subjected to torque loading in the test configuration of FIGS. 7-8;

FIG. 10 is a simulated stress profile of the appliance of FIGS. 1-3 when subjected to torque loading in the test configuration of FIGS. 7-8.

### DEFINITIONS

As used herein:

“Mesial” means in a direction toward the midline (i.e. the center of a patient's curved dental arch).

“Distal” means in a direction away from the midline.

“Occlusal” means in a direction toward the outer tips of the patient's teeth.

“Gingival” means in a direction toward the patient's gums or gingiva.

“Facial” means in a direction toward the patient's lips or cheeks.

“Lingual” means in a direction toward the patient's tongue.

### DETAILED DESCRIPTION

Exemplary embodiments are now described in greater detail with reference to the accompanying drawings. These embodiments are directed to orthodontic appliances, as well as related methods of making the same, and methods of enhancing torque strength in the same. While the appliances presented here are facial appliances (intended to be attached to the front sides of the teeth), the invention can also be practiced in the context of lingual appliances (intended to be attached to the back sides of the teeth). That is, where “lingual” is specified, this term may be exchanged with “facial,” as it is clear to one of ordinary skill in the art that the provided appliances and methods can be useful on both sides of the teeth.

An orthodontic bracket according to one embodiment is shown in FIGS. 1-3 and represented by the numeral 100. As shown in these figures, the bracket 100 has a base 102 with an outer surface 104 adapted for attachment to a tooth surface of a patient undergoing orthodontic treatment. Optionally, the outer surface 104 has a concave contour and is provided with grooves, particles, recesses, undercuts, a chemical bond enhancement material, or any other material or structure or combination thereof that facilitates bonding the bracket 100 to the tooth surface.

As further shown in FIGS. 1-3, the bracket 100 further includes a body 106 extending outwardly in a generally facial direction from the base 102. An elongated archwire slot 108 extends across the facial surface of the body 106 along a generally mesial-distal direction. The archwire slot 108 has a longitudinal axis 109 (shown in FIGS. 2 and 3) also extending in a generally mesial-distal direction, and is defined by opposing mesial sidewalls 110, 112, opposing distal sidewalls 111, 113, and bottom wall 114. Optionally and as shown, the bottom wall 114 is generally planar and orthogonal with adjacent sidewalls 110, 111, 112, 113. While the archwire slot 108 has an opening that generally faces the facial direction, the slot 108 could also face other directions. For example, in lingual appliances, the archwire slot 108 can advantageously have an opening toward the occlusal direction to facilitate archwire insertion.

In this embodiment, the body 106 is part of a twin bracket appliance having mesial and distal members 116, 118 that are spaced apart from each other. Extending outwardly from the members 116, 118 are a respective mesial pair of tiewings 120 and distal pair of tiewings 122. As shown, each pair of tiewings 120, 122 protrude in generally occlusal and gingival directions. The archwire slot 108 as a whole extends between each pair of mesial and distal tiewings 120, 122, and further includes discrete mesial and distal sections 124, 126.

As part of a twin appliance, each section 124, 126 has its own geometry and each can be independently ligated to an archwire if the practitioner desires. As shown in FIGS. 1 and 2, the mesial sidewalls 110, 112 are generally planar and non-parallel, as are the distal sidewalls 111, 113. As an alternative, either the mesial sidewalls 110, 112 or the distal sidewalls 110, 112 could be parallel. Optionally and as shown, an integral distal hook 128 protrudes from the distal tiewing 122 to aid in placement of elastics, headgear, elastic chains, and the like.

FIGS. 2 and 3 show further geometric aspects of the archwire slot 108. At this point, it is emphasized that certain characteristics of the archwire slot 108 have been intentionally exaggerated in FIGS. 1-5 to aid in illustrating distinctive features of the embodiments described. In other words, these figures are not to scale and should not be construed as a rendering of the actual archwire slot geometries used in these embodiments.

Each of the sidewalls 110, 111, 112, 113 of the archwire slot 108 has a linear taper such that the transverse (here, occlusal-gingival) dimension of the archwire slot 108 varies along its length (along its longitudinal axis 109). As shown, the archwire slot 108 has terminal mesial and distal ends located on the respective mesial and distal sides of the bracket 100. The transverse dimension strictly increases with increasing proximity to the nearest terminal mesial or distal end of the archwire slot 108.

As further illustrated in FIGS. 1 and 2, the tapered sidewalls 110, 111, 112, 113 generally display occlusal-gingival symmetry about a horizontal reference plane 130 (also shown in FIG. 3) perpendicular to the bottom wall 114 and coplanar with the longitudinal axis 109. As further illustrated, the tapered sidewalls 110, 111, 112, 113 generally display mesial-distal symmetry about a vertical reference plane 132 perpendicular to the longitudinal axis 109 and passing between the mesial and distal members 116, 118 of the body 106. These symmetries, however, are not perfect because of the overall rhomboidal shape of the bracket.

Consider the interaction between the mesial section 124 of the archwire slot 108 and a rectangular archwire that is in a state of asymmetric torque. The taper in one or both of the sidewalls 110, 112 allows the interfacial contact area between a full-sized rectangular archwire received in the archwire slot 108 and the bracket 100 to be substantially distributed along the length of the archwire slot 108 when the archwire is twisted about its longitudinal axis. Preferably, the degree of taper is based on a twisted archwire configuration that could realistically occur during the course of treatment, such as when initially placing a rectangular archwire on a maloccluded dentition, or replacing an existing archwire after making significant torque adjustments. Archwire configurations that would only be realized by applying unduly high levels of torque to the archwire could be excluded from consideration in determining the appropriate taper for the sidewalls 110, 112.

For archwire configurations likely to be encountered during the course of treatment, finite element analysis (FEA) can be used to predict the distribution of contact stress between a twisted archwire and the sidewalls 110, 111, 112, 113 of the bracket 100. As shall be shown, these studies demonstrated that a small degree of taper can be beneficial in de-localizing stress between the archwire and the bracket 100. These same studies also demonstrated that implementing a taper angle that is too high can again lead to undesirable localization of contact stress between the archwire and the bracket 100.

In some embodiments, the sidewalls 110, 112 have a relative angular deviation relative to each other of at least about 0.5 degrees, at least about 0.75 degrees, at least about 1.0 degrees, at least about 1.25 degrees, or at least about 1.5 degrees. In some embodiments, the sidewalls 110, 112 have a relative angular deviation relative to each other of up to about 10 degrees, up to about 8 degrees, up to about 6 degrees, up to about 4 degrees, or up to about 2 degrees relative to each other. Described another way, the angular deviation of each sidewall 110, 112 relative to the horizontal reference plane 130 is preferably at least about 0.25 degrees, at least about 0.375 degrees, at least about 0.5 degrees, at least about 0.625 degrees, or at least about 0.75 degrees. The angular deviation of each sidewall 110, 112 relative to the horizontal reference plane 130 is preferably up to about 5 degrees, up to about 4 degrees, up to about 3 degrees, up to about 2 degrees, or up to about 1 degree.

The above description can apply by analogy, and independently, to opposing distal sidewalls 111, 113 on the distal section 126 of the archwire slot 108 and thus will not be repeated here.

The archwire slot 108 need not have the symmetric configuration described above and illustrated in FIGS. 1-3. For example, depending on the directionality and degree of archwire torque expected, it may be advantageous for the archwire slot 108 to have sidewalls 110, 111, 112, 113 that are asymmetrically disposed about the horizontal reference plane 130. Asymmetry in the sidewalls 110, 111, 112, 113 about the vertical reference plane 132 may also be desirable in some cases. In an alternative embodiment, for example, fewer than all of the sidewalls 110, 111, 112, 113 are tapered relative to the horizontal reference plane 130. In another embodiment, all of the sidewalls 110, 111, 112, 113 are so tapered, but have differing degrees of taper relative to each other.

In the embodiments described, each sidewall 110, 111, 112, 113 is tapered along its entire length. However, this need not be the case. For example, the opposing sidewalls 110, 112 could be tapered over one region of its length and parallel over the remaining region of its length. Alternatively, the degree of taper could vary, either sharply or smoothly, at various locations along its length of the archwire slot 108. Some of these aspects are further exemplified below.

FIG. 4 shows an orthodontic bracket 200 according to another embodiment. The bracket 200 has a similar configuration to the bracket 100 except for the geometry of its archwire slot 208. As shown in the figure, the mesial side of the archwire slot 208 has opposing sidewalls 210, 212, each sidewall 210, 212 being tapered along less than all of its mesial-distal length. Here, the sidewall 210 includes a parallel region 210a and a tapered region 210b. Similarly, the sidewall 212 includes parallel and tapered regions 212a and 212b, respectively.

From a distal-to-mesial (left-to-right) direction, the transverse dimension of the slot 208 remains substantially constant along the length of the parallel regions 210a, 212a and strictly increases along the length of the tapered regions 210b, 212b. Notably, in the same direction, the transverse dimension of the slot 208 is monotonically increasing (in other words, non-decreasing) along the entire length of the sidewalls 210, 212. Similar observations can be made with respect to the distal side of the archwire slot 208, which is substantially the mirror-image of its mesial side.

Use of a parallel archwire slot section, as shown in the bracket 200, can advantageously provide a high degree of control between the archwire and the bracket 200 while maintaining the advantages of spreading out the contact stress near the ends of the archwire slot 208.

A parallel archwire slot section is also present in FIG. 5, which shows an orthodontic bracket 300 according to still another embodiment. The bracket 300 is a non-twin appliance that includes an archwire slot 308 with opposing sidewalls 310, 312 that define an overall slot geometry similar to that of the bracket 200. Unlike the bracket 200, however, the sidewalls 310, 312 extend along the entire length of the archwire slot 308 without interruption. As further shown, the sidewalls 310, 312 include distal tapered regions 310a, 312a, central parallel regions 310b, 312b, and mesial tapered regions 310c, 312c.

In a distal-to-mesial direction, the transverse dimension of the slot 308 strictly decreases along the distal regions 310a, 312a, remains constant along the central regions 310b, 312b, and strictly increases along the mesial regions 310c, 312c. Along the same reference direction, the transverse dimension of the slot 308 is monotonically increasing along the entire length of the central and mesial regions 310b, 312b, 310c, 312c, but not along the distal regions 310a, 312a. Finally, along this direction, the transverse dimension of the slot 308 is monotonically decreasing along the entire length of the distal and central regions 310a, 312a, 310b, 312b, but not along the mesial regions 310c, 312c.

In some embodiments, the transverse slot dimension is strictly increasing or decreasing along at least about 5 percent, at least about 8 percent, at least about 10 percent, at least about 12 percent, or at least about 15 percent of the overall length of the archwire slot 108, 208, 308. In some embodiments, the transverse slot dimension is strictly increasing or decreasing along up to about 50 percent, up to about 45 percent, up to about 40 percent, up to about 35 percent, or up to about 30 percent of the overall length of the archwire slot 108, 208, 308.

In some embodiments, the transverse slot dimension is monotonically increasing or decreasing along at least about 30 percent, at least about 35 percent, at least about 40 percent, at least about 43 percent, or at least about 45 percent of the overall length of the archwire slot 108, 208, 308. In some embodiments, the transverse slot dimension is monotonically increasing or decreasing along up to about 75 percent, up to about 70 percent, up to about 65 percent, up to about 62 percent, or up to about 60 percent of the overall length of the archwire slot 108, 208, 308.

As a result of the tapered sidewalls in these embodiments, the transverse dimension of the mesial and distal ends of the archwire slot 108, 208, 308 is increased beyond its nominal specification (18 mils (0.46 millimeters) or 22 mils (0.56 millimeters) for common orthodontic brackets) by a certain margin. In some embodiments, the certain margin is at least about 0.5 mils (0.013 millimeters), at least about 0.6 mils (0.015 millimeters), at least about 0.7 mils (0.018 millimeters), at least about 0.75 mils (0.019 millimeters), or at least about 0.8 mils (0.020 millimeters). In some embodiments, the certain margin is up to about 1.0 mils (0.025 millimeters), up to about 1.2 mils (0.030 millimeters), up to about 1.5 mils (0.038 millimeters), up to about 2.0 mils (0.051 millimeters), or up to about 3.0 mils (0.076 millimeters). In a preferred embodiment, an archwire slot having a nominal 018 (18 mil, or 0.46 millimeter) slot dimension could have a 19 mil (or 0.48 millimeter) transverse dimension at its mesial and distal ends.

FIG. 6 shows a bracket 400 according to yet another embodiment, this one illustrating a non-linear taper. As shown, the bracket 400 has an archwire slot 408 with opposing sidewalls 410, 420 that are curved rather than planar. Depending on the shape of the archwire when it is twisted about its longitudinal axis, use of one or more continuously curved sidewalls can assist in spreading the contact stress between the archwire and appliance uniformly, particularly when the contacting surfaces substantially match each other. In some embodiments, it may be advantageous to have a curved sidewall section interposed between two adjacent planar sidewall sections to avoid stress localization where they come together. For example, in the bracket 300 of FIG. 5, the gingival and occlusal sidewall sections 310a, 310b, 310c, 312a, 312b, 312c could have radiused junctions or be otherwise interconnected by curved sidewall sections.

Numerous technical advantages derive from appliances with tapered archwire slots as provided above. First, these archwire slot geometries can re-distribute stress induced by the archwire on the bracket; rather than being concentrated at the terminal end of the slot, the stress can be spread more evenly along the length of the archwire slot. This re-distribution of stress can substantially increase torque strength relative to the torque strength of brackets having non-tapered slots. In some embodiments, the torque strength of the bracket can be increased by at least 20 percent, at least 30 percent, at least 40 percent, or at least 50 percent by virtue of tapering the sidewalls of the archwire slot. Only a slight change to bracket slot geometry can be sufficient to realize this benefit. As such, a major re-design of the bracket can be obviated.

Second, the tapered sidewalls potentially allow the bracket to be made significantly smaller while maintaining the same torque strength as the unmodified bracket. This is especially beneficial to ceramic brackets, since these brackets are prone to brittle fracture and thus tend to be larger than their metal counterparts. Various other benefits can accrue from the smaller bracket size, such as lower bracket profile, greater patient comfort, and increased bond reliability.

Third, the tapered sidewalls can potentially mitigate the effects of notching or galling produced by contact between the archwire and the bracket. Again, ceramic brackets particularly benefit here, because of the hardness disparity between ceramics and metals. This hardness disparity can give rise to observable wire damage, commonly occurring at the ends of the archwire slot. By providing a geometry that helps conform the walls of the archwire slot to those of the archwire surface, the provided appliances could benefit from reduced damage to the archwire during treatment. Since this surface damage results in increased friction, avoidance of such damage can decrease resistance to sliding and enhance treatment efficiency.

The provided appliances can be made from any number of materials suitable for use in the oral cavity. For example, the appliances could be made from a metal such as stainless steel, gold, or titanium, a ceramic such as mono- or poly-crystalline aluminum oxide, or a polymer composite such as a glass-filled polycarbonate. Particularly suitable materials include fine-grained polycrystalline aluminum oxides described in U.S. Pat. No. 6,648,638 (Castro, et al.). As another option, the appliances could include an archwire slot at least partially defined by an archwire slot liner that could also be tapered. Various types of archwire liners are described, for example, in U.S. Pat. No. 5,358,402 (Reed, et al.) and U.S. Patent Publication Nos. 2007/0134610 (Wyllie et al.), 2008/0081309 (Wyllie, et al.), and 2008/0070182 (Wyllie, et al.).

Besides the choice of materials, any known manufacturing methods known to one of skill in the art are can also be used to shape the provided appliances. Exemplary methods include milling, casting, rapid prototyping, metal-injection molding and investment casting, and variations thereof. Preferably, the manufacturing method selected has sufficient precision to replicate the tapered sidewalls enabling the beneficial stress distribution profiles described herein.

FIG. 7 shows a simplified test apparatus 50 used to simulate the contact stress on an exemplary bracket 52. This stress is produced by applying an asymmetric torque to an archwire 54 engaged to the bracket 52 as shown. In the apparatus 50, the bracket 52 is positioned such that the archwire 54 is fully seated in the slot of the bracket 52 and then fixed in space. The archwire 54 has adjacent and remote grippers 56, 58, which are rigidly coupled to the terminal ends of the archwire 54. To simulate an asymmetric torque situation, the gripper 56 is gradually rotated to observe the stress concentration profile along the outer surface of the bracket 52. The gripper 58 is constrained to a fixed location in space but is allowed to freely rotate. Finite Element Analysis (FEA) was performed on the bracket 52 using ANSYS engineering simulation software (version 12, from ANSYS in Canonsburg, Pa.).

FIG. 8 shows, in greater detail, how the shape of the archwire 54 is twisted when torque is applied by the gripper 56. It is notable that the twist in the archwire 54 can be observed even within the slot of the bracket 52. FEA can be used to examine the force interaction between the bracket 52 and the archwire 54.

The results of the FEA are shown in FIGS. 9 and 10, which show the stress concentration profile on brackets 60, 62 with non-tapered and tapered archwire slots, respectively. In both simulations, one end of the archwire 54 was twisted as described above until a pre-defined maximum stress was obtained. Upon meeting this condition, the stress profile along the archwire slot surfaces was captured. Here, the magnitude of the stress concentration was indicated by a visual contrast—i.e. darker shades indicate higher stress values. In both simulations, conducted under identical test setups, stress on the bracket 60, 62 was observed along the sidewalls of the respective archwire slots. Comparing the bracket 60 in FIG. 9 to the bracket 62 in FIG. 10, however, it can be appreciated that the tapered slot resulted in a uniformly distributed stress profile, while the non-tapered slot resulted in a stress profile localized at the distal end of the archwire slot.

### Torque Strength Test

This section describes torque strength tests conducted to illuminate the benefits of the provided orthodontic appliances. Each test was conducted using a specially tapered archwire received in the archwire slot of a conventional ceramic orthodontic bracket. Here, the tapering of opposing sides of the archwire was used as a proxy to demonstrate the effect of tapering the sidewalls of the archwire slot.

### Bracket Bonding

All torque strength measurements were performed using lower left cuspid CLARITY brand Advanced ceramic brackets (3M Unitek in Monrovia, Calif.) having 018 (18 mil, or 0.46 millimeter) archwire slots. It is to be understood, however, that other bracket systems such as TRANSCEND brand ceramic brackets (3M Unitek in Monrovia, Calif.) could also be used in these torque strength measurements. Each bracket was bonded to a stainless steel knurled ring having a convex compound curvature that conforms to the contour of the cuspid bracket base. For convenience, up to 10 bracket specimens can be bonded along the circumference of a single knurled ring.

To bond the brackets, TRANSBOND brand XT Light Cure Adhesive Primer (REF 712-034, 3M Unitek in Monrovia, Calif.) was applied to the ring and TRANSBOND brand XT Light Cure Adhesive Paste (REF 712-036, 3M Unitek in Monrovia, Calif.) was applied to the bracket base, according to manufacturer's instructions. The bracket was then radially mounted to the outer edge of the ring, with its archwire slot aligned parallel to the central axis of the ring. Finally, the adhesive was cured using an ORTHOLUX brand LED Curing Light (REF 704-360, 3M Unitek in Monrovia, Calif.) according to manufacturer's instructions.

### Rectangular Wires

Tapered rectangular wires were prepared from straight lengths of 018×025 HI-T brand II stainless steel rectangular wires (REF 256-825, 3M Unitek in Monrovia, Calif.). Each wire was precisely machined to taper the “A”-dimension (018) along an intermediate segment of the rectangular wire. Depending on the sample, the taper extended along either the overall archwire slot length of each bracket (a length of approximately 0.070 inches, or 1.8 millimeters) or one half of the archwire slot length (a length of approximately 0.035 inches, or 0.89 millimeters). Along the tapered segment, the transverse dimension of the wire ranged from about 16 mils (0.48 millimeters) to about 18 mils (0.46 millimeters), corresponding to a taper angle of about 1 degree over the entire slot length or 2 degrees over one-half of the slot length. Each taper can be characterized as a pair of triangular notches in registration with each other on opposite sides of the wire, each notch having a depth linearly ranging from 0 to 0.001 inches (0.0025 millimeters).

In this idealized torque test configuration, programming an x degree taper on opposite sides of a rectangular wire as described above, effectively simulates the effect of x degree taper in the opposing sidewalls of an archwire slot.

### Torque Strength Equipment

Tests were conducted using an MTS QTest/5 Test Machine (MTS Systems, Eden Prairie, Minn.), outfitted with a torque strength test fixture. This fixture has a pair of opposing wire grippers positioned approximately 0.953 inches (24.2 millimeters) apart. The first gripper is allowed to freely rotate, while the second gripper is controlled by the Test Machine. The fixture converts a tensile force to a rotational force using a flexible chain that partially encircles a 1.92 inch (4.88 centimeter) diameter sprocket, in turn attached to the second gripper. The knurled ring containing the bracket(s) was mounted to a vertically adjustable chuck located between the grippers.

### Torque Measurements

The test was set up by mounting the wire ends in the grippers and positioning the chuck with the knurled ring to align the wire in the archwire slot of the bracket. Care was taken to longitudinally center the tapered segment with the slot to avoid contact between the terminal edge of taper and the bracket slot. The rotating gripper was spaced approximately 0.20 inches (5.1 millimeters) away from the leading edge of the bracket slot, as shown schematically in FIG. 7. To commence the test, the crosshead of the Test Machine was then translated upwards at a fixed rate of 2.0 inches/minute (50.8 millimeters/minute) thereby driving counterclockwise rotation of the second gripper at a rotational speed of approximately 12 degrees/minute. In the meantime, torque was then continuously measured by a load cell and recorded as a function of the linear extension of the crosshead. The test was terminated when either 1) bracket breakage was detected (as indicated by an initial peak in torque value) or 2) the fixture reached the upper limit of extension limit, 0.80 inches (20.3 millimeters).

In Table 1 below, Samples 1-3 represent the torque test results obtained using a non-tapered wire, a wire having a 1 degree taper extending along the entire slot length, and a wire having a 2 degree taper extending along one half of the slot length nearest the second gripper. Included in Table 1 are the sample size, nominal wire size, taper angle, taper length, torque strength, and change in torque strength relative to non-tapered Sample 1. As reported below, the values of torque test strength reflect the numerical average of at least 7 replicated measurements.

TABLE 1
Torque strength measurement data

| | | | Taper | Taper | | Change |
|---|---|---|---|---|---|---|
| | | Nominal | angle | length/ | Average torque | in torque |
| Sample | N | wire size | (degrees) | Slot length | strength (N-cm) | strength |
| 1 | 7 | 018x025 | 0 | — | 2.96 ± 0.17 | — |
| 2 | 9 | 018x025 | 1 | 1 | 4.75 ± 0.42 | +60.4% |
| 3 | 7 | 018x025 | 2 | 0.5 | 4.94 ± 0.25 | +67.1% |

As indicated by Table 1, both of the tapered wire configurations measured significantly higher average torque strength than the non-tapered wire configuration.

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

What is claimed is:

1. An orthodontic appliance comprising:
a base;
a body extending outwardly from the base; and
an elongated archwire slot extending across the body along a generally mesial-distal direction, the slot at least partially bounded by a bottom wall and a pair of substantially planar sidewalls, wherein at least one region of at least one sidewall is tapered to provide a transverse slot dimension that varies along the length of the archwire slot, the pair of sidewalls having an relative angular deviation ranging from about 0.5 to about 10 degrees.

2. (canceled)

3. The appliance of claim 1, wherein the pair of sidewalls have an relative angular deviation ranging from about 1.5 to about 2 degrees.

4-6. (canceled)

7. An orthodontic appliance comprising:
a base;
a body extending outwardly from the base; and
an elongated archwire slot extending across the body along a generally mesial-distal direction, the slot at least partially bounded by a bottom wall and a pair of opposing sidewalls, wherein at least one sidewall is tapered to provide a transverse slot dimension that varies along the length of the archwire slot, whereby the transverse slot dimension monotonically increases or decreases over about 30 to about 75 percent of the overall length of the archwire slot.

8. The appliance of claim 7, wherein all of the tapered sidewalls are substantially planar.

9. The appliance of claim 7, wherein all of the tapered sidewalls are continuously curved.

10. (canceled)

11. The appliance of claim 7, wherein the transverse slot dimension monotonically increases or decreases along about 45 to about 60 percent of the overall length of the archwire slot.

12. (canceled)

13. The appliance of claim 7, wherein the transverse slot dimension strictly increases or decreases along about 10 to about 40 percent of the overall length of the archwire slot.

14. (canceled)

15. The appliance of claim 1, wherein the transverse dimension of the archwire slot has a nominal value and the transverse dimension of the mesial and distal ends of the archwire slot is increased beyond its nominal value by a selected margin ranging from about 0.13 millimeters to about 0.76 millimeters.

16. The appliance of claim 15, wherein the selected margin ranges from about 0.18 millimeters to about 0.38 millimeters.

17. (canceled)

18. The appliance of claim 1, the archwire slot having a longitudinal axis and the tapered sidewalls generally having mesial-distal symmetry about a vertical reference plane perpendicular to the longitudinal axis.

19. The appliance of claim 1, the archwire slot having a longitudinal axis and the tapered sidewalls generally having occlusal-gingival symmetry about a horizontal reference plane parallel to the longitudinal axis.

20. The appliance of claim 1, wherein the archwire slot further comprises:
a mesial section;
a distal section; and
a central section located between mesial and distal sections, wherein the central section has substantially parallel sidewalls and the mesial and distal sections have tapered sidewalls.

21. The appliance of claim 20, wherein the mesial and distal sections collectively extend across up to about 70 percent of the overall length of the archwire slot.

22. (canceled)

23. The appliance of claim 21, wherein the mesial and distal sections collectively extend across up to about 55 percent of the overall length of the archwire slot.

24. (canceled)

25. The appliance of claim 1, wherein the appliance comprises a ceramic material.

26. A method of enhancing torque strength in a ceramic orthodontic appliance comprising:
providing a ceramic body; and
providing an elongated archwire slot into the body, the archwire slot having a pair of opposing sidewalls and one or both sidewalls being tapered to provide a transverse dimension that varies along the length of the archwire slot whereby the interfacial contact area between a full-sized rectangular archwire received in the archwire slot and the appliance is substantially distributed along the length of the archwire slot as the archwire is twisted about its longitudinal axis.

27. The method of claim 26, wherein all of the tapered sidewalls are substantially planar.

28. (canceled)

29. The method of claim 26, wherein the archwire slot further comprises:
a tapered mesial section;
a tapered distal section; and
a central section located between mesial and distal sections and having substantially parallel sidewalls to provide enhanced control of the rectangular archwire over the appliance.

30. The method of claim 26, wherein the torque strength of the ceramic appliance as determined using a Torque Strength Test is increased by at least 20 percent relative to the torque strength of a reference appliance without tapered sidewalls.

31. (canceled)

32. The method of claim 30, wherein the torque strength of the ceramic appliance as determined using the Torque Strength Test is increased by at least 40 percent relative to the torque strength of a reference appliance without tapered sidewalls.
